(19) United States
(12) Patent Application Publication
(10) Pub. No.: US 2026/0356110 A1
(43) Pub. Date: Nov. 12, 2026

(54) SHEET FEEDING DEVICE AND IMAGE FORMING APPARATUS

(71) Applicant: CANON KABUSHIKI KAISHA, Tokyo (JP)

(72) Inventors: HIROSHI FUKUZO, Tokyo (JP); SEIICHIRO ADACHI, Chiba (JP); TAKUYA YAMAGUCHI, Chiba (JP)

(21) Appl. No.: 19/542,849

(22) Filed: Feb. 18, 2026

(30) Foreign Application Priority Data
May 9, 2025 (JP) 2025-078354

(51) Int. Cl. B41J 13/10; A47B 88/467; B41J 29/13

(52) U.S. Cl. CPC B41J 13/103; A47B 88/467; B41J 29/13

(57) ABSTRACT

A sheet feeding device includes a casing, an accommodating portion movably provided between a mounting position to the casing and a drawn-out position drawn out of the casing, an engaged portion provided on the accommodating portion and a drawing-in unit provided on the casing. The drawing-in unit is provided with an engaging portion engageable with the engaged portion and a spring connected to the engaging portion and to generate an urging force to draw in the accommodating portion in a drawing-in direction from the drawn-out position toward the mounting position. In a case where the accommodating portion is moved from the drawn-out position toward the mounting position, the engaging portion is engaged with the engaged portion and the movement of the accommodating portion is stated by the spring, and then, when the accommodating portion reaches a predetermined position between the mounting position and the drawn-out position, the movement is stopped.

### BACKGROUND

### Field of the Technology

The present disclosure relates to a sheet feeding device which feeds a sheet and an image forming apparatus utilizing the same.

### DESCRIPTION OF THE RELATED ART

In Japanese Patent Application Laid-Open No. 2014-104049, a drawing-in mechanism which draws in, upon mounting a drawer, which is drawn out to a front side, to a cabinet main body, the drawer to a mounting position at which the drawer is mounted on the cabinet main body with a small force. However, as to a configuration which draws in a sheet accommodating portion such as a drawer, in addition to a weight of the sheet accommodating portion itself, a weight of sheets accommodated in the sheet accommodating portion is added, and a total weight becomes large. In this case, in order to draw in the sheet accommodating portion to the mounting position, a drawing-in mechanism equipped with a large drawing-in force becomes necessary. On the other hand, in the drawing-in mechanism equipped with the large drawing-in force, in a case in which an amount of the sheet is small, there is a possibility that the sheet accommodating portion is vigorously drawn in to the mounting position. This causes generation of an abnormal noise, etc. upon the drawing-in.

### SUMMARY

The present disclosure provides, with respect to a sheet accommodating portion equipped with a drawing-in function, a sheet feeding device which reduces an abnormal noise, etc. generated upon mounting.

An aspect of the present disclosure is a sheet feeding device comprising: a casing; a sheet accommodating portion movably provided between a mounting position at which the sheet accommodating portion is mounted to the casing and a drawn-out position drawn out of the casing and configured to accommodate a sheet; an engaged portion provided on either one of the casing and the sheet accommodating portion; and a drawing-in unit provided on the other one of the casing and the sheet accommodating portion, and provided with an engaging portion engageable with the engaged portion and a first urging member connected to the engaging portion and configured to generate an urging force to draw in the sheet accommodating portion in a drawing-in direction from the drawn-out position toward the mounting position, wherein in a case in which the sheet accommodating portion is moved from the drawn-out position toward the mounting position, the engaging portion and the engaged portion are in engagement with each other and the movement of the sheet accommodating portion in the drawing-in direction is stated by the first urging member of the drawing-in unit, and then, when the sheet accommodating portion reaches a predetermined position between the mounting position and the drawn-out position, the movement of the sheet accommodating portion in the drawing -in direction by the first urging member of the drawing-in unit is stopped.

Further features of the present invention will become apparent from the following description of exemplary embodiments with reference to the attached drawings. The following description of embodiments is described by way of example.

### BRIEF DESCRIPTION OF THE DRAWINGS

FIG. 1 is a cross-sectional view illustrating an image forming system according to the present Embodiment.

FIG. 2 is a perspective view illustrating a feeding module according to the present Embodiment.

FIG. 3 is a perspective view illustrating a first sheet storage according to the present Embodiment.

FIG. 4 is a perspective view illustrating a front side plate unit according to the present Embodiment.

Part (a) of FIG. 5 is a perspective view illustrating an internal structure of the first sheet storage in a state in which a storage frame according to the present Embodiment is attached, and part (b) of FIG. 5 is a perspective view illustrating the internal structure of the first sheet storage in a state in which the storage frame according to the present Embodiment is detached.

Part (a) of FIG. 6 is a perspective view illustrating an internal configuration of a main body frame according to the present Embodiment, and part (b) of FIG. 6 is a perspective view illustrating a positioning roller according to the present Embodiment.

FIG. 7 is a side view illustrating a drawing-in unit when the first sheet storage according to the present Embodiment is positioned at a drawing-in start position.

FIG. 8 is a side view illustrating the drawing-in unit when the first sheet storage according to the present Embodiment is positioned at a drawing-in completion position.

FIG. 9 is a side view illustrating the first sheet storage according to the present Embodiment.

FIG. 10 is a side view illustrating a state in which the first sheet storage according to the present Embodiment is positioned at a drawn-out position.

FIG. 11 is a side view illustrating a state in which the first sheet storage according to the present Embodiment is positioned at the drawing-in start position and movement of a moving member starts.

FIG. 12 is a side view illustrating a state in which the first sheet storage according to the present Embodiment is positioned at the drawing-in start position and the movement of the moving member is completed.

FIG. 13 is a side view illustrating a state in which the first sheet storage according to the present Embodiment is positioned at the drawing-in completion position.

FIG. 14 is a side view illustrating a state in which the first sheet storage according to the present Embodiment is positioned at a mounting position.

### DESCRIPTION OF THE EMBODIMENTS

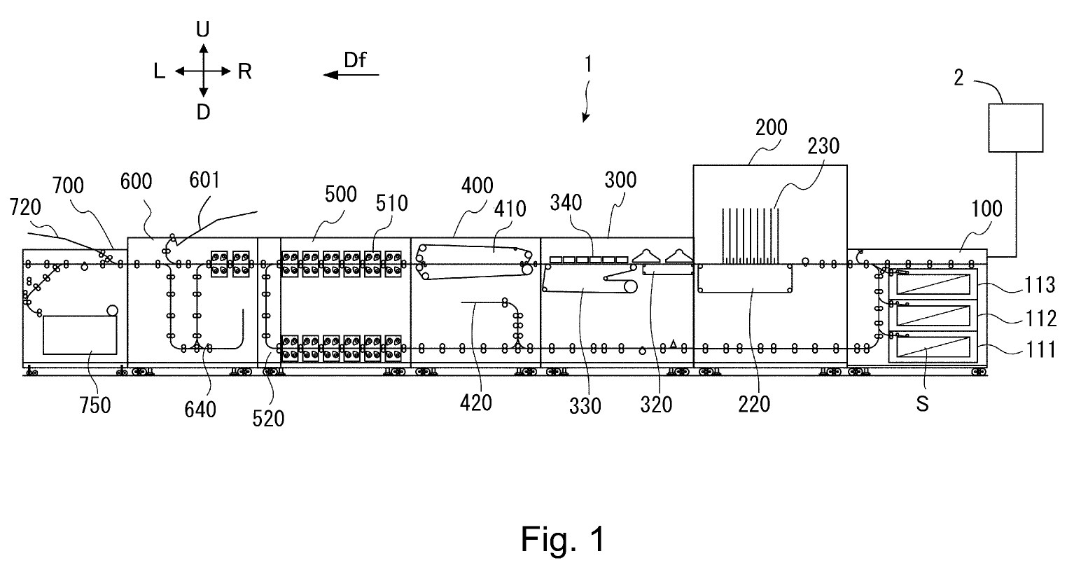

Hereinafter, the present Embodiment will be described using FIG. 1 through FIG. 14. In the present Embodiment, a case in which an image forming apparatus is applied as an inkjet recording system 1 is described. FIG. 1 is a schematic view illustrating an example of an outline configuration of the inkjet recording system 1. This inkjet recording system 1 is an inkjet recording system of a sheet-feeding type, which produces a recorded product in which an ink image is formed on a sheet S using two liquids of reaction fluid and ink. As shown in FIG. 1, the inkjet recording system 1 is constituted by a feeding module 100, a printing module 200, a drying module 300, a fixing module 400, a cooling module 500, a reversing module 600 and a stacking module 700. The sheet S having a cut paper shape supplied from the feeding module 100 is conveyed along a conveyance path, processed by each module, and stacked in the stacking module 700. Incidentally, the sheet in the present Embodiment is a recording material, and includes a paper such as a sheet and an envelope, a plastic film such as a sheet for an overhead projector (OHP), cloth, etc. In addition, in the present Embodiment, the inkjet recording system 1 is placed so that a sheet conveyance direction Df becomes a left-right direction of the inkjet recording system 1, and a right side as facing the system is described as a right direction R, a left side as facing the system is described as a left direction L, an upside is described as an up direction U, and a downside is described as a down direction D. In addition, a front side as facing the inkjet recording system 1 is described as a front direction F, a back side is described as a back direction B, and a width direction crossing (perpendicular to) the sheet conveyance direction Df is described as a front-back direction FB.

The feeding module 100 is an example of a sheet feeding device, and by conveying the sheet with being connected to the printing module 200, supplies the sheet to the printing module 200, and performs sending and receiving of the sheet with the printing module 200. The feeding module 100 includes, as a sheet storage which accommodates and feeds the sheet S, a first sheet storage 111, a second sheet storage 112, and a third sheet storage 113. In each sheet storage, a plurality of the sheets S are accommodated, and the sheets S are separated in each sheet storage, fed one by one, and conveyed to the printing module 200. Incidentally, the number of the sheet storages is not limited to three, but may be a configuration having one or two, or four or more.

The printing module 200 includes a pre image forming registration correcting portion, a printing belt unit 220, and a recording portion 230, and conveys the sheet S. The sheet S conveyed from the feeding module 100 is conveyed to the printing belt unit 220 after a tilt and a position of the sheet S are corrected by the pre image forming registration correcting portion. The recording portion 230 is disposed at a position, with respect to the conveyance path, opposite to the printing belt unit 220. The recording portion 230 is an example of an image forming portion, and forms an image on the sheet S accommodated in and fed from the first sheet storage 111, the second sheet storage 112, and the third sheet storage 113. The sheet S printed in the recording portion 230 is conveyed, while ensuring clearance with the recording heads, by being suctioned and conveyed by the printing belt unit 220. As to the sheet S printed in the recording portion 230, misalignment and color density of the image formed on the sheet S is detected by an in-line scanner disposed on a downstream side of the recording portion 230 in the sheet conveyance direction. A detection result thereof is utilized for correction of a print image.

The drying module 300 includes a decoupling portion 320, a drying belt unit 330, and a hot air blowing portion 340, reduces a liquid content contained in the ink applied onto the sheet S in the recording portion 230 of the printing module 200, and enhances fixing performance of the ink to the sheet S. The sheet S printed by the recording portion 230 of the printing module 200 is conveyed to the decoupling portion 320 disposed on an upstream side of the drying module 300 in the sheet conveyance direction. The decoupling portion 320 can convey the sheet S with wind pressure from above and friction with a belt, and by weakly holding and conveying the sheet S on the belt, prevents misalignment of the sheet S, on which the ink image is formed, on the printing belt unit 220. The drying belt unit 330 is disposed below the belt, and the hot air blowing portion 340 is disposed above the belt so as to be opposite to each other across the belt. The sheet S conveyed from the decoupling portion 320 is suctioned and conveyed by the drying belt unit 330, and at the same time, a surface on which the ink is applied is dried by receiving hot air from the hot air blowing portion 340. Incidentally, as for a drying type, in addition to the type applying the hot air, it may be configured by combining a type irradiating the surface of the sheet S with electromagnetic waves (such as ultraviolet rays and infrared rays) and a conduction heat transfer type through a contact of a heat generating element.

The fixing module 400 includes a fixing belt unit 410. The fixing belt unit 410 includes an upper belt unit and a lower belt unit, and by causing the sheet S conveyed from the drying module 300 to pass through between the heated upper belt unit and the lower belt unit, can fix the ink to the sheet S.

The cooling module 500 includes a plurality of cooling portions 510, and cools the sheet S of high temperature conveyed from the fixing module 400 through the sheet conveyance path. The cooling portion 510 is configured to cool the sheet S by sucking outside air into a cooling box with a fan, increasing pressure in the cooling box, and applying air blown out from a nozzle, which is formed on a conveyance guide, to the sheet S. The cooling portion 510 is disposed on both of an upper side and a lower side with respect to the conveyance path, and cools the sheet S from both sides.

The reversing module 600 includes a second reversing portion 640, and can reverse a front and back of the sheet S to be conveyed and change a front-back orientation of the sheet S to be discharged. The reversing module 600 includes a discharge tray 601, which may be used as a sheet retracting destination.

The stacking module 700 includes a top tray 720, a stacking unit 750, and a registration unit, and aligns and stacks the sheet S conveyed from the reversing module 600. In the stacking module 700, using the registration unit, in order to improve alignment before stacking, oblique movement correction of the sheet and lateral registration correction, which corrects deviation in the width direction, are performed. Incidentally, in the present Embodiment, registration correction in the width direction is referred to as the lateral registration correction.

In addition, in the present Embodiment, to the inkjet recording system 1, a print server 2 is connected, and a print job is sent from the print server 2. In the print server 2, it is possible to confirm a state of the inkjet recording system 1, monitor the print job, and execute maintenance control, and it is possible to collectively operate various types of functions which the inkjet recording system 1 includes.

A case of double-side printing will be described. The cooling module 500 includes a conveyance path switching portion 520, which can switch the conveyance path of the sheet S depending on a case in which the sheet S is conveyed to the reversing module 600 and a case in which the sheet S is conveyed to a double-side conveyance path, which is used in the case of the double-side printing. Upon the double-side printing, the sheet S is conveyed to a conveyance path in a lower portion of the cooling module 500. In this case, the sheet S is further conveyed along the double-side conveyance path of the cooling module 500, the fixing module 400, the drying module 300, the printing module 200, and the feeding module 100. To the double-side conveyance path of the fixing module 400, a first reversing portion 420, which reverses the front and back of the sheet S, is provided. As to the reversed sheet, the oblique movement correction and/or the lateral registration correction of the sheet S are executed by a registration unit provided in the double-side conveyance path of the drying module 300. Thereafter, again, the sheet is conveyed from the feeding module 100 through the pre image forming registration correcting portion of the printing module 200, the printing belt unit 220, and the recording portion 230, and the sheet is printed in the recording portion 230.

### Feeding module

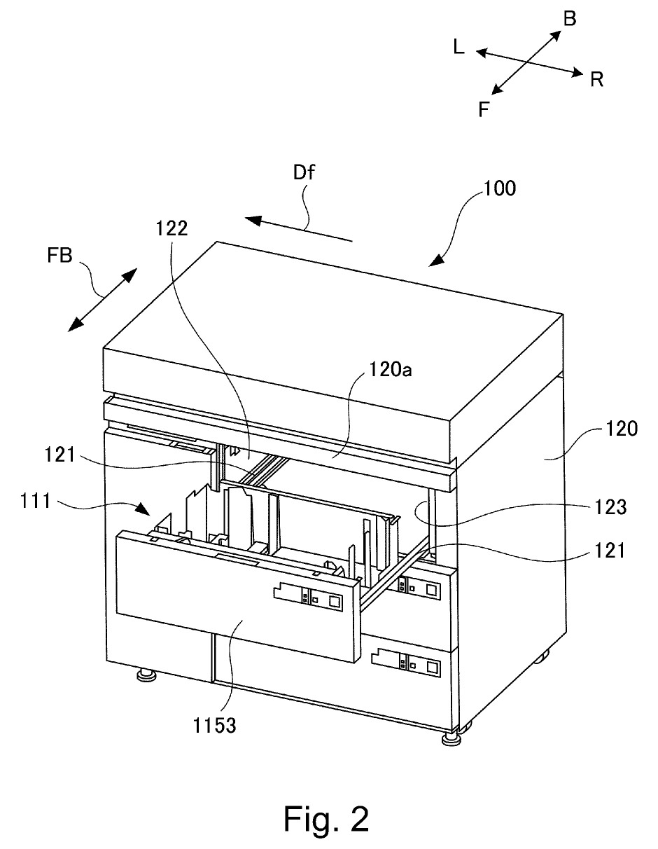

Next, a configuration of the feeding module 100 will be described. FIG. 2 is a perspective view illustrating the feeding module 100 in a state in which the first sheet storage 111 is drawn out. In the present Embodiment, since the first sheet storage 111, the second sheet storage 112, and the third sheet storage 113 have the same configuration, hereinafter, the first sheet storage 111 will be described as a representative. Incidentally, in the present Embodiment, a case in which the first sheet storage 111, the second sheet storage 112, and the third sheet storage 113 have the same configuration will be described, however, it is not necessary to have the same configuration. For example, the first sheet storage 111, the second sheet storage 112, and the third sheet storage 113 may be configured so that respective heights thereof are different so that maximum storage numbers of the sheets are different.

The first sheet storage 111 is mounted so as to be capable of being drawn out with respect to a main body frame 120, which is an example of a casing of the feeding module 100. The first sheet storage 111 is held by a left side plate 122 and a right side plate 123 provided on the main body frame 120 via slide rails 121, respectively. The first sheet storage 111 is held by the main body frame 120 so as to be movable in the front-back direction FB between a mounting position, at which the first sheet storage 111 is pushed in toward the back side of the main body frame 120 and closed, and a drawn-out position, at which the first sheet storage 111 is drawn out to the front side of the main body frame 120. In other words, the first sheet storage 111, the second sheet storage 112, and the third sheet storage 113 are examples of a sheet accommodating portion, which accommodates the sheet, and a moving unit. The first sheet storage 111, the second sheet storage 112, and the third sheet storage 113 are movable between the mounting position at which the storages are mounted to the main body frame 120 and the drawn-out position at which the storages are drawn out of the main body frame 120. In a state in which the first sheet storage 111 is at the drawn-out position, it is possible to add and exchange the sheet to the first sheet storage 111. Here, the drawn-out position of the first sheet storage 111 is a position for a user to replenish and/or exchange the sheet. In the present Embodiment, the first sheet storage 111 may be positioned, by being drawn out further than the drawn-out position, at a maintenance position for a service representative to exchange a component and/or perform maintenance.

### Storage

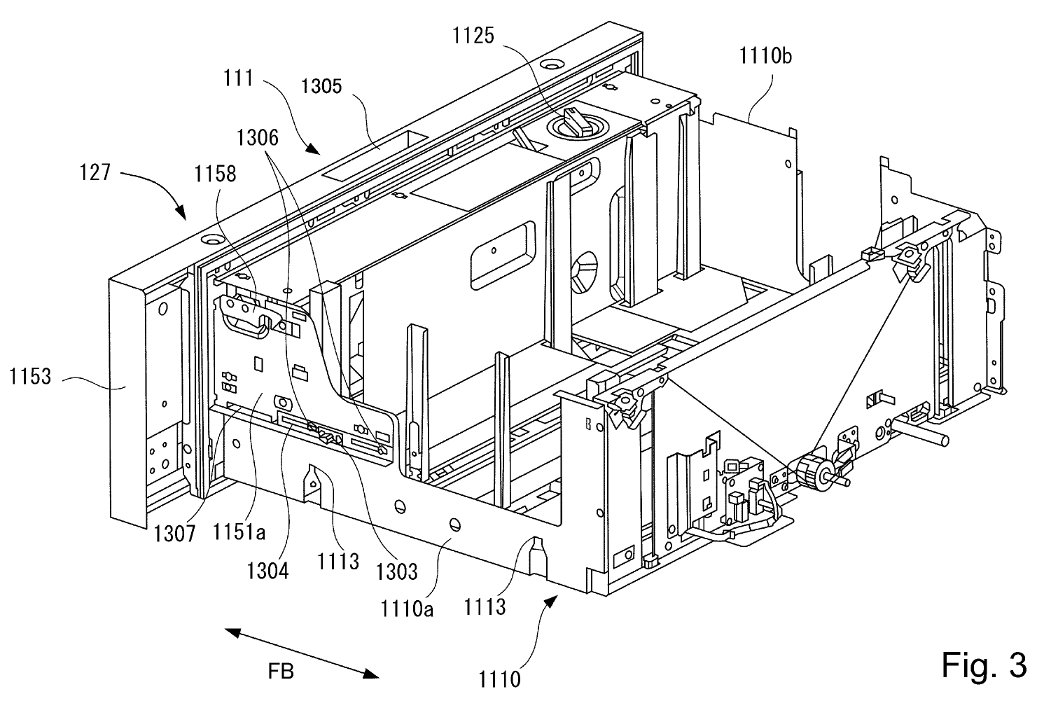

Next, a configuration of the first sheet storage 111 will be described. FIG. 3 is a perspective view of the first sheet storage 111. On the first sheet storage 111, a storage frame 1110 constituting a wall surface thereof is provided. In a right side portion 1110a and a left side portion 1110b of the storage frame 1110, two hole portions for the rail 1113 are provided, respectively. By hooking the hole portion for the rail 1113 to a rivet 1220 (see part (a) of FIG. 6) of the slide rail 121, the first sheet storage 111 is held by the slide rail 121.

In the right side portion 1110a and the left side portion 1110b of the storage frame 1110, lateral registration adjusting plates 1151a and 1151b are provided, respectively. The lateral registration adjusting plates 1151a and 1151b are attachable to the right side portion 1110a and the left side portion 1110b of the storage frame 1110 so that positions thereof in the front-back direction FB with respect to the storage frame 1110 are adjustable. On the lateral registration adjusting plates 1151a and 1151b, moving members 1304 movable in the front-back direction FB are provided. In addition, to the moving member 1304, a contacting portion 1303 which contacts and engages with a drawing-in unit 130 (see part (a) of FIG. 6) is fixedly provided. The contacting portion 1303 is an example of an engaged portion, and is provided on the first sheet storage 111 side in the present Embodiment. In addition, by being provided on the moving member 1304, the contacting portion 1303 is provided movably in the front-back direction FB with respect to the first sheet storage 111.

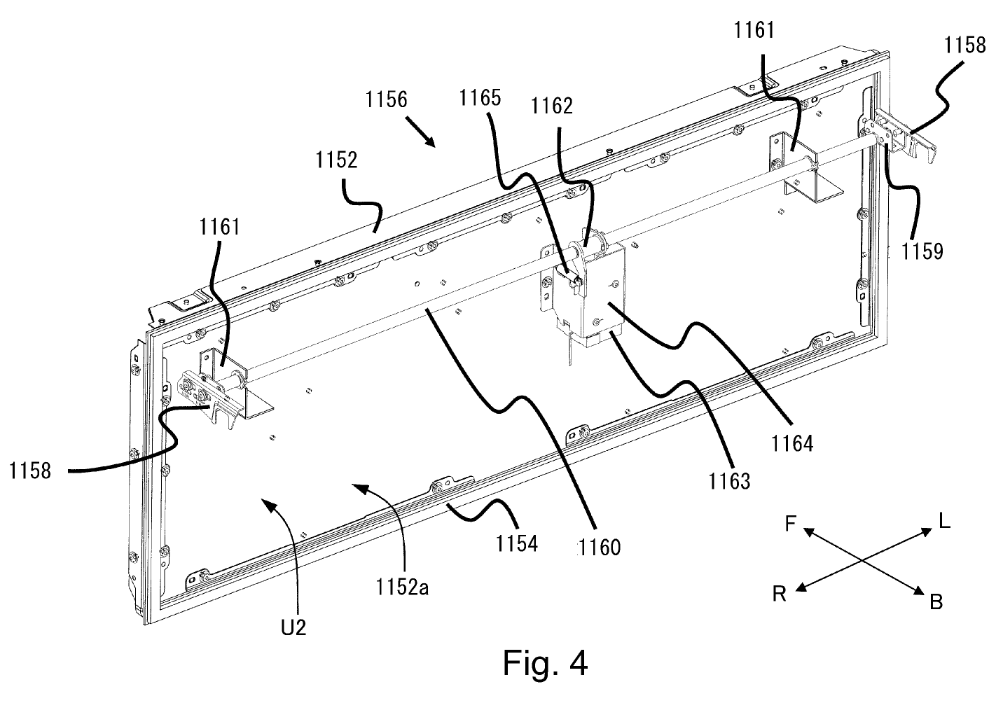

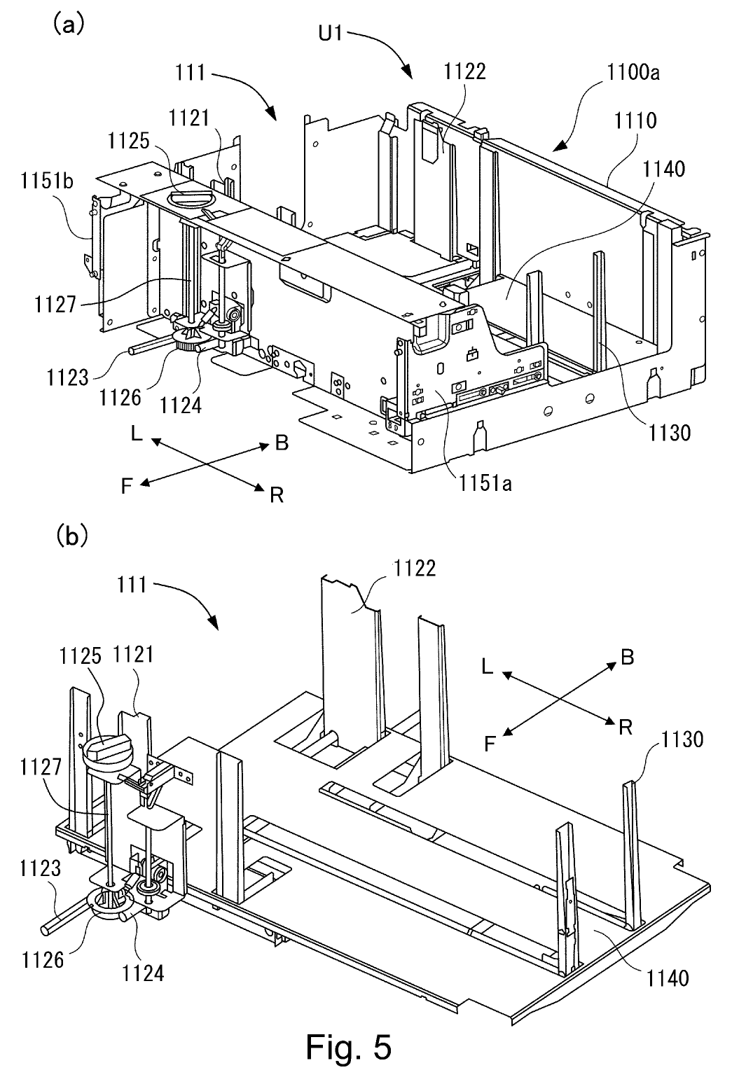

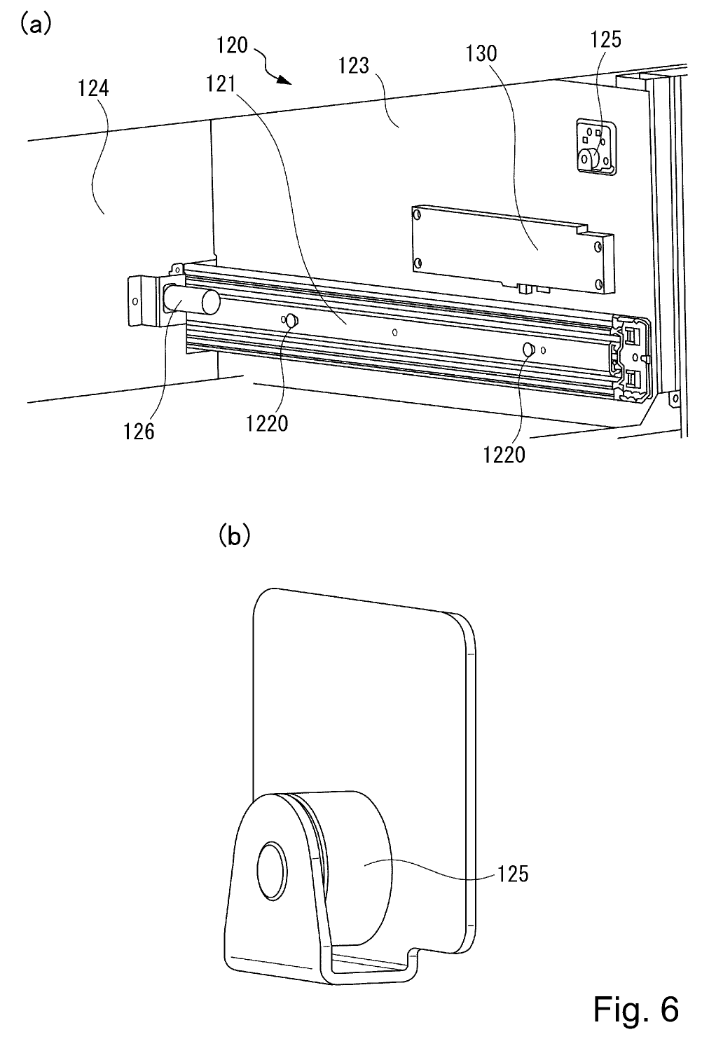

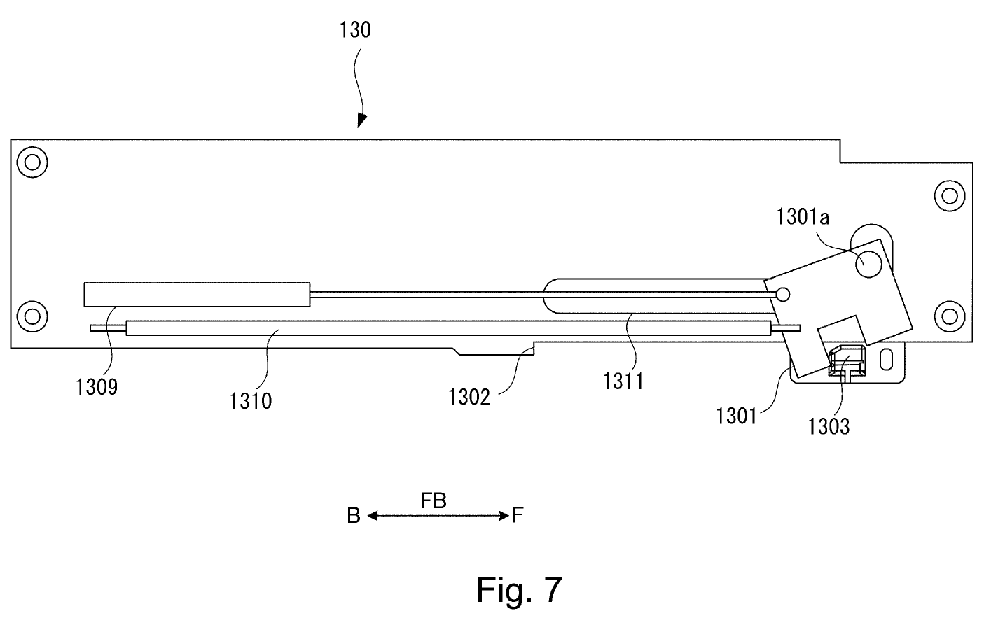

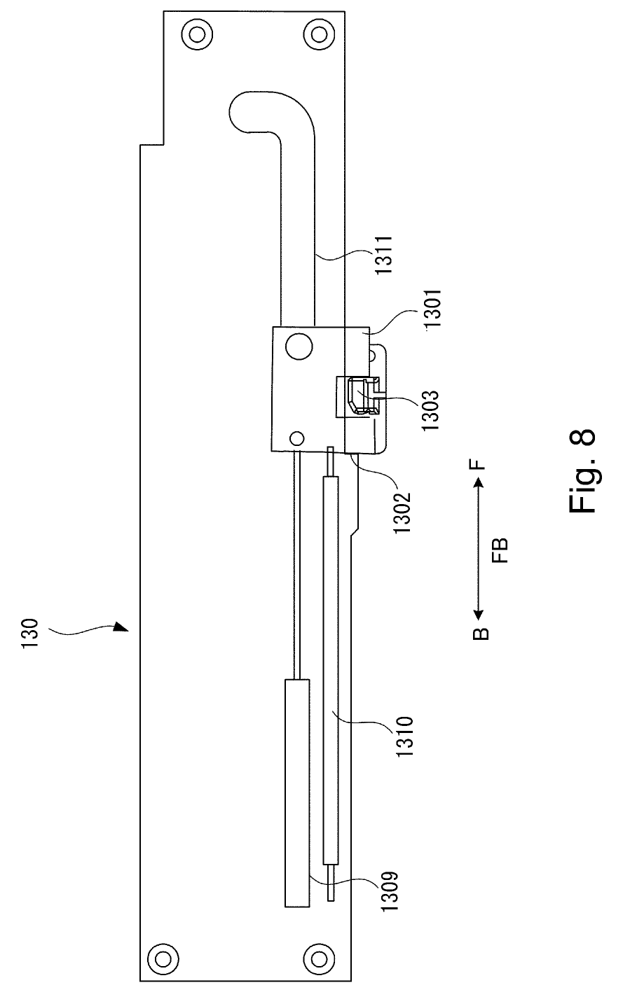

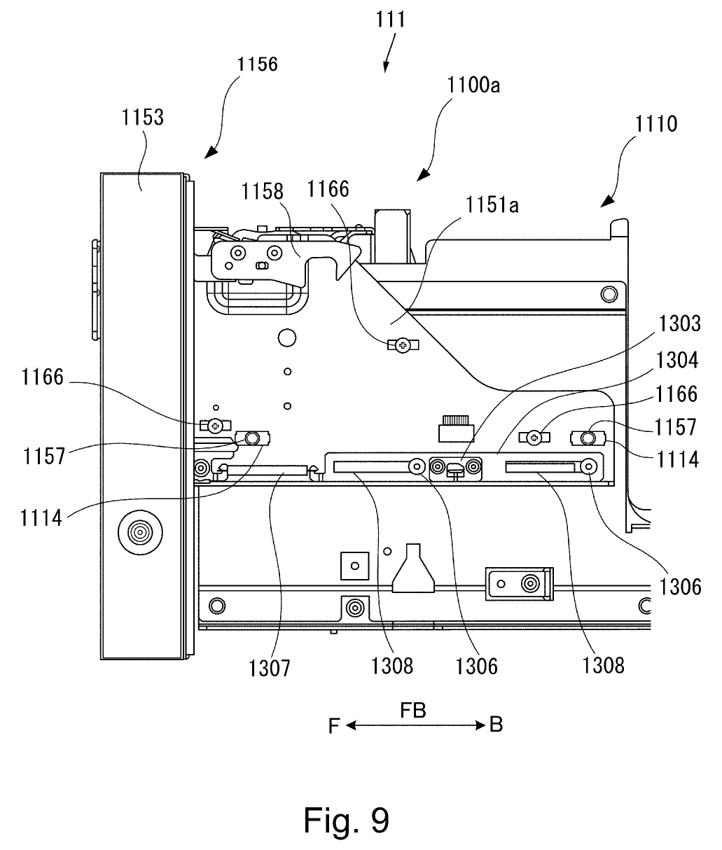

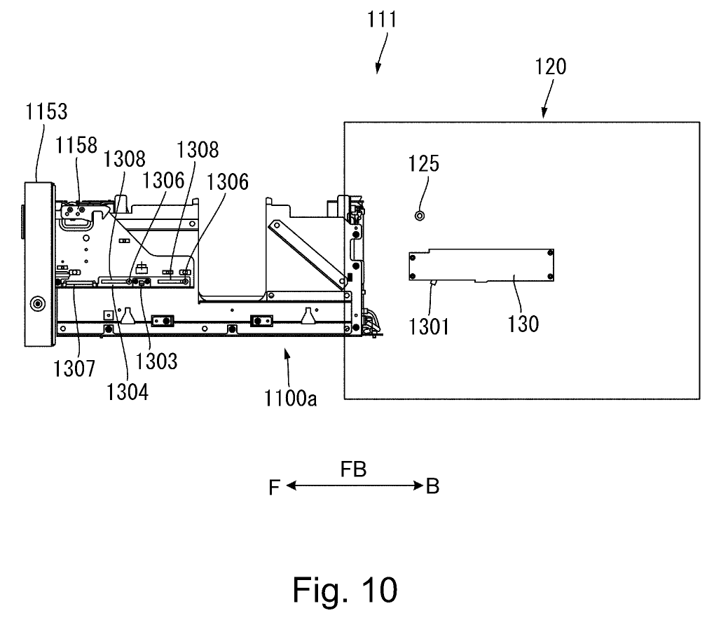

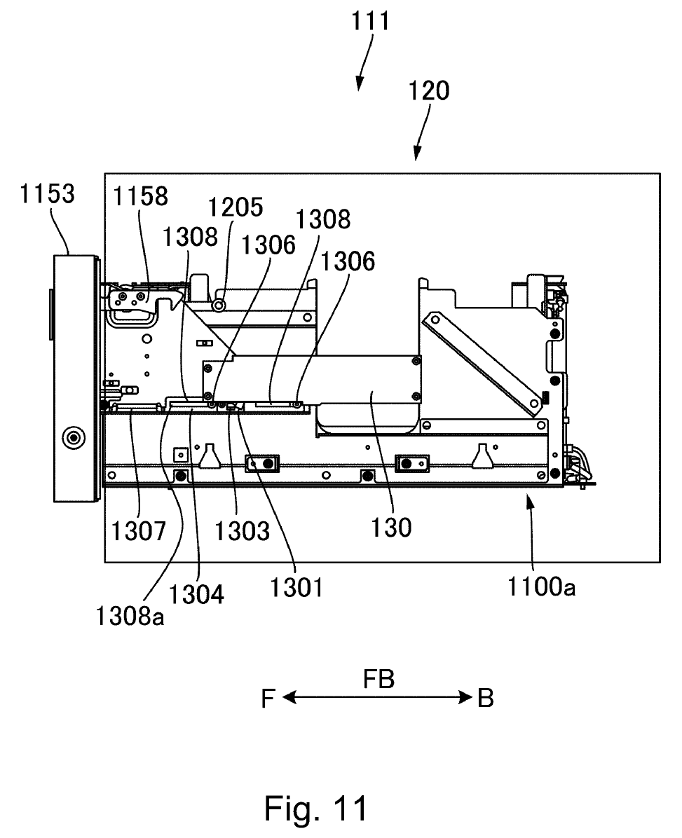

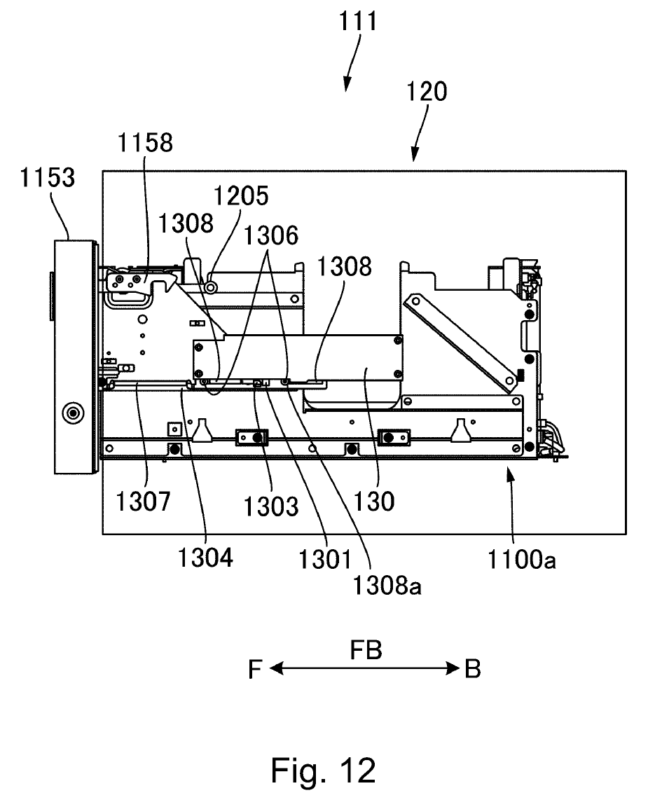

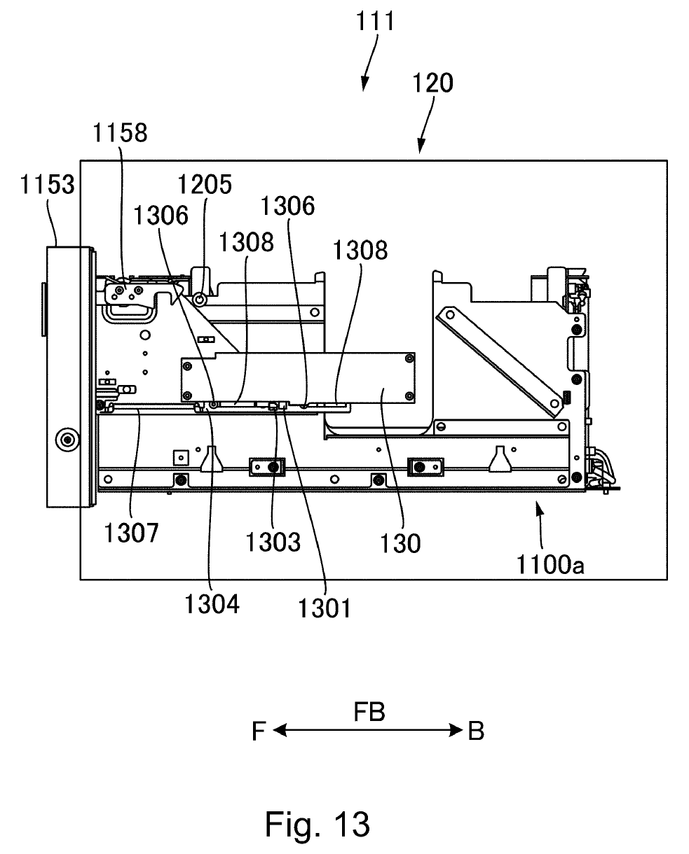

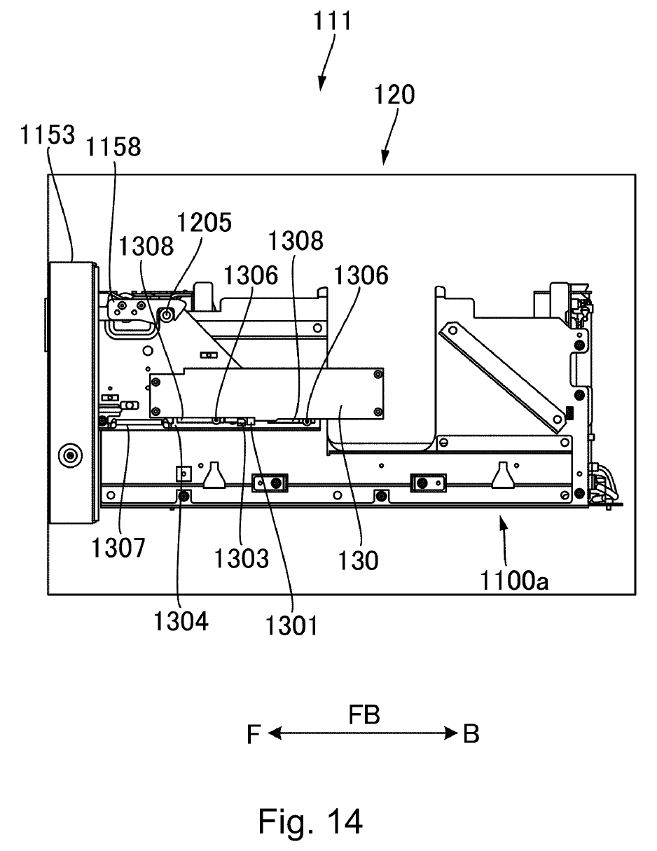

On the first sheet storage 111, a front side plate 1152 (see FIG. 4) is provided. To a front side of the front side plate 1152, an exterior cover 1153 is fixed. On the feeding module 100, a latch unit 127 for performing positioning of the first sheet storage 111 in the front-back direction FB with respect to the main body frame 120 is provided. The latch unit 127 is an example of a holding unit, and includes a latch claw 1158 having a hooking shape provided on the first sheet storage 111, and a positioning roller 125 provided on the main body frame 120. The latch claw 1158 is attached to the front side plate 1152. In other words, to the front side plate 1152, the exterior cover 1153 and the latch claw 1158 are integrally attached. The front side plate 1152 and the latch claw 1158 integrally constitute a front side plate unit 1156 (see FIG. 4). In other words, the latch unit 127 is displaceable between a holding state of holding the first sheet storage 111 with the latch claw 1158 being engaged with the positioning roller 125 at the mounting position and a releasing state of releasing the holding to the mounting position with the latch claw 1158 being separated from the positioning roller 125.

### Front side plate unit

Next, a configuration of the front side plate unit 1156 will be described. FIG. 4 is a perspective view of the front side plate unit 1156. The latch claw 1158 is fixed to a latch shaft 1160 via a latch base 1159. The latch shaft 1160 is rotatably held by a latch shaft supporting base 1161. The latch shaft supporting base 1161 is fixed to the front side plate 1152. To the latch shaft 1160, a link arm 1162 is fixed. To the front side plate 1152, a solenoid 1163 is fixed via a solenoid supporting plate 1164. Between the solenoid supporting plate 1164 and the link arm 1162, a solenoid spring 1165 is disposed. The solenoid spring 1165 urges the latch shaft 1160 in a clockwise direction as viewing the feeding module 100 from the right side thereof.

In other words, in a case in which the solenoid 1163 is in an OFF state, the latch claw 1158 is urged in a direction of engaging with the positioning roller 125 by an urging force of the solenoid spring 1165, and engages therewith. On the other hand, by the solenoid 1163 being switched to an ON state, the latch claw 1158 is rotated in a direction of being separated from the positioning roller 125 against the urging force of the solenoid spring 1165. Incidentally, it is necessary to arrange so as the internal components of the first sheet storage 111 and components fixed to the main body frame 120 or the main body frame 120 itself not to be interfered with each other when drawing out the first sheet storage 111 from the main body frame 120.

### Storage frame

Next, a configuration of the storage frame 1110 will be described. Part (a) of FIG. 5 is a perspective view illustrating an internal structure of the first sheet storage 111 in a state in which the storage frame 1110 is attached thereto. Part (b) of FIG. 5 is a perspective view illustrating the internal structure of the first sheet storage 111 in a state in which the storage frame 1110 is detached therefrom.

The first sheet storage 111 includes, as the internal structure thereof, a pair of side guide portions 1121 and 1122, an operating portion 1125 which operates the pair of side guide portions 1121 and 1122, a trailing end guide portion 1130, and a lifter plate 1140. The pair of side guide portions 1121 and 1122 are side end portion regulating members which regulates positions of both end portions of the sheet in the front-back direction FB (width direction) perpendicular to the sheet conveyance direction Df. The storage frame 1110 and the pair of side guide portions 1121 and 1122 constitute a first unit U1. The trailing end guide portion 1130 is a trailing end regulating member which regulates a position of a trailing end portion of the sheet in the sheet conveyance direction Df. The lifter plate 1140 is configured to be capable of being lifted and lowered. The lifter plate 1140 is lifted by a driving force of a driving motor, and raises a bundle of the sheets stacked on a sheet stacking surface of the lifter plate 1140.

Next, a configuration of the operating portion 1125 which operates the pair of side guide portions 1121 and 1122 will be described. To the pair of side guide portions 1121 and 1122, rack members 1123 and 1124 extending in parallel with the front-back direction FB are provided. The rack members 1123 and 1124 are held by the storage frame 1110 so as to be movable in the front-back direction FB. On the rack members 1123 and 1124, rack teeth are formed on side surfaces thereof opposite to each other. Each rack tooth meshes with a gear 1126 disposed between the rack members 1123 and 1124.

When one of the pair of side guide portions 1121 and 1122 is moved in the front-back direction FB, a force is transmitted to the other one of the pair of side guide portions 1121 and 1122 via the gear 1126, and the pair of side guide portions 1121 and 1122 is moved by the same distance in directions opposite to each other. In other words, the gear 1126 interlocks the pair of side guide portions 1121 and 1122 so that the pair of side guide portions 1121 and 1122 is moved by the same distance in the directions opposite to each other.

The operating portion 1125 is rotatable manually, and is provided on an upper portion of the storage frame 1110 on a front side of the first sheet storage 111. The operating portion 1125 is coaxially connected to the gear 1126 by a rotation shaft 1127 of which a rotation center (rotational axis) is in the up-down direction. By a user rotating to operate the operating portion 1125, the gear 1126 is rotated, and the pair of side guide portions 1121 and 1122 is moved in the front-back direction FB via the rack members 1123 and 1124. As a result, it is possible to widen or narrow a width between the pair of side guide portions 1121 and 1122 in the front-back direction FB according to sheet widths of the sheets stacked in the first sheet storage 111.

The lateral registration adjusting plates 1151a and 1151b provided on the right side portion 1110a and the left side portion 1110b of the storage frame 1110, respectively, are attachable to the storage frame 1110 with being adjusted in the front-back direction FB. In the respective lateral registration adjusting plates 1151a and 1151b, gap-like two elongated holes 1114 (see FIG. 9), of which a longitudinal direction is in the front-back direction FB, are provided. The respective two elongated holes 1114 in the lateral registration adjusting plates 1151a and 1151b are engaged with lateral registration adjusting pins 1157 provided on the right side portion 1110a and the left side portion 1110b, respectively. As a result, positions of the lateral registration adjusting plates 1151a and 1151b in the front-back direction FB are adjustable with respect to the storage frame 1110. The lateral registration adjusting plates 1151a and 1151b are fixed, after the positions thereof in the front-back direction FB are adjusted, to the right side portion 1110a and the left side portion 1110b by lateral registration adjusting plate screws 1166 (see FIG. 9), respectively.

The first unit U1, which includes the storage frame 1110 and the pair of side guide portions 1121 and 1122, is configured so that a position thereof relative to a second unit U2, which includes the latch claw 1158 and an inner side surface 1152a of the front side plate 1152, can be changed. The lateral registration adjusting plates 1151a and 1151b are attached to the storage frame 1110 so that positions thereof in the front-back direction FB with respect to the first unit U1 are adjustable. By this, it becomes possible to change the position of the first unit U1 relative to the second unit U2.

### Main body frame

Next, a configuration of the main body frame 120 of the feeding module 100 will be described. Part (a) of FIG. 6 is a perspective view of an internal configuration of the main body frame 120. The main body frame 120 is configured to hold the first sheet storage 111 movably in the front-back direction FB. On an inner surface of the right side plate 123 of the main body frame 120, the positioning roller 125, which has an approximately cylindrical shape and is engageable with the hooking shape of the latch claw 1158, is rotatably provided. On a back side plate 124 of the main body frame 120, a pushing-out spring 126 is provided. The pushing-out spring 126 is an example of a second urging member provided on the main body frame 120, and urges the first sheet storage 111 in a direction opposite to a drawing-in direction from the mounting position. When the first sheet storage 111 is inserted into the main body frame 120, the first sheet storage 111 receives an urging force in the front direction F (a drawing-out direction) of the feeding module 100 by the pushing-out spring 126. In this state, when the latch claw 1158 engages with the positioning roller 125 and the latch unit 127 is in an engaged state, a position of the first sheet storage 111 in the front-back direction FB is determined as the mounting position. In addition, in a case in which the first sheet storage 111 is positioned at the mounting position and the latch unit 127 is in the releasing state, the pushing-out spring 126 urges the first sheet storage 111 toward a drawing-in completion position and causes the first sheet storage 111 to be moved from the mounting position.

### Drawing-in unit

On each inner surface of the left side plate 122 and the right side plate 123 of the main body frame 120, the drawing-in unit 130 is provided. The drawing-in unit 130 contacts the contacting portion 1303 provided on the first sheet storage 111, and draws in the first sheet storage 111 toward the back side of the main body frame 120 via the contacting portion 1303. Incidentally, in the present Embodiment, a case in which the latch claw 1158 having the hooking shape is provided on the front side plate 1152, and the positioning roller 125 having the approximately cylindrical shape is provided on the main body frame 120 is described. However, it is not limited thereto, but the latch claw may be provided on the main body frame 120, and the positioning roller may be provided on the front side plate 1152.

Next, the drawing-in unit 130 will be described. FIG. 7 and FIG. 8 are side views of the drawing-in unit 130, and FIG. 7 shows when the first sheet storage 111 is positioned at a drawing-in start position, and FIG. 8 shows when the first sheet storage 111 is positioned at the drawing-in completion position. The drawing-in unit 130 includes a claw portion 1301, a damper 1309, and a drawing-in spring 1310. The damper 1309 and the drawing-in spring 1310 are connected to the claw portion 1301, respectively. The claw portion 1301 is an example of an engaging portion, and is engageable with the contacting portion 1303. The drawing-in spring 1310 is an example of a first urging member, is connected to the claw portion 1301, and generates an urging force for drawing in the first sheet storage 111 in the drawing-in direction (back direction B) directed from the drawn-out position toward the mounting position. The damper 1309 is an example of a damping member, and regulates a moving speed of the first sheet storage 111 in the drawing-in direction.

As shown in FIG. 7, the claw portion 1301 includes a pin portion 1301a. The claw portion 1301 is positioned, in a state of being urged in the back direction B by the drawing-in spring 1310, by the pin portion 1301a being hooked in an internal groove 1311 of the drawing-in unit 130. When the first sheet storage 111 is moved from the drawn-out position in the back direction B and reaches the drawing-in start position, the contacting portion 1303 contacts the claw portion 1301, the claw portion 1301 is disengaged from the hooking with the internal groove 1311, and starts drawing-in of the contacting portion 1303 in the back direction B. Incidentally, an end portion of the internal groove 1311 in the front direction F has a shape bent upward, and by the pin portion 1301a being positioned at this end portion, the pin portion 1301a is locked against the drawing-in spring 1310.

As shown in FIG. 8, when the claw portion 1301 of the drawing-in unit 130 draws in the contacting portion 1303 until the contacting portion 1303 stops, the first sheet storage 111 is drawn in to the drawing-in completion position and stops. The drawing-in unit 130 includes an abutting portion 1302 against which the claw portion 1301 abuts in the back direction B when the first sheet storage 111 is positioned at the drawing-in completion position. As a result, the claw portion 1301 is urged in the back direction B by the drawing-in spring 1310, and is drawn in up to the abutting portion 1302.

At this time, the claw portion 1301 is not only urged in the back direction B by the drawing-in spring 1310, but also receives a reaction force in an opposite direction to the back direction B by the damper 1309. However, the reaction force of the damper 1309 is set to be smaller than the force of the drawing-in spring 1310. By this action of the damper 1309, the claw portion 1301 does not operate very rapidly up to the abutting portion 1302, but operates relatively slowly. In addition, by the claw portion 1301 engaging with the contacting portion 1303, and urging the contacting portion 1303 in the back direction B, it becomes possible to urge the first sheet storage 111 provided with the contacting portion 1303 in the back direction B as well.

With the configuration described above, in the drawing-in unit 130, the drawing-in spring 1310 urges the first sheet storage 111 including the contacting portion 1303, and assists the operation in which the first sheet storage 111 is moved in the drawing-in direction (back direction B). In addition, by the damper 1309 applying the reaction force to the first sheet storage 111 including the contacting portion 1303, it becomes possible to absorb an impact to be generated by the drawing-in spring 1310.

In addition, in the present Embodiment, in a case in which the first sheet storage 111 is moved between the drawing-in completion position shown in FIG. 8 and the mounting position, the claw portion 1301 and the contacting portion 1303 engaged with each other are moved relative to the first sheet storage 111, and are not moved to the main body frame 120. By this, between the drawing-in completion position and the mounting position, it becomes possible to design behavior of the first sheet storage 111 without being affected by the drawing-in spring 1310 and the damper 1309 of the drawing-in unit 130. In addition, between the drawing-in completion position and the mounting position, resistance of the damper 1309 does not act on the movement of the first sheet storage 111, so that it becomes possible to reduce a load upon an operation by a user.

On an upper surface of the exterior cover 1153 of the first sheet storage 111, a handle 1305 (see FIG. 3) having a recessed shape is formed, and a user may draw out the first sheet storage 111 by gripping the handle 1305. The handle 1305 is an example of a gripping portion, and the user grips the handle 1305 upon drawing out the first sheet storage 111. Here, it is desired to prevent that an error is generated by the user gripping the handle 1305 and drawing out the first sheet storage 111 when the lifter plate 1140 is being lifted or lowered, etc. Therefore, in the present Embodiment, it is configured that when the first sheet storage 111 is positioned at the mounting position, the handle 1305 is hidden by a front panel 120a positioned above the first sheet storage 111 in a front portion of the main body frame 120. In other words, the front panel 120a is an example of a shielding portion, and shields the handle 1305 when the first sheet storage 111 is positioned at the mounting position. By this, it is configured that when the first sheet storage 111 is at the mounting position, the user may not touch the handle 1305. In addition, it is configured that when the first sheet storage 111 is positioned at the drawing-in completion position, the handle 1305 is exposed so that the user may operate.

Incidentally, the front panel 120a functions as the shielding portion for the first sheet storage 111, however, the exterior cover 1153 of the first sheet storage 111 functions as the shielding portion for the second sheet storage 112. In addition, for the third sheet storage 113, the exterior cover of the second sheet storage 112 functions as the shielding portion.

### Operation upon drawing out the first sheet storage from the mounting position

When the first sheet storage 111 positioned at the mounting position is drawn out, with an electrical input from an outside, the solenoid 1163 (see FIG. 4) provided on the front side plate unit 1156 is driven and drawn in. As a result, the latch shaft 1160 is urged, and the engagement between the latch claw 1158 and the positioning roller 125 is released. Then, by the pushing-out spring 126 provided on the back side plate 124 of the main body frame 120, the first sheet storage 111 is urged in the front direction F of the feeding module 100. As a result, the first sheet storage 111 is moved to a position at which the user can grip the handle 1305, and the user can draw out the first sheet storage 111 to the drawn-out position by gripping the handle 1305.

### Operation of the drawing-in unit and the moving member

FIG. 9 is a side view illustrating the lateral registration adjusting plate 1151a viewed from the right side of the first sheet storage 111. By loosening the lateral registration adjusting plate screw 1166, the lateral registration adjusting plate 1151a becomes movable in the front-back direction FB with respect to the first sheet storage 111, so that it is possible to adjust the position of the first sheet storage 111 in the front-back direction FB with respect to the front side plate unit 1156. A maximum adjustment amount may be set by a dimension of a gap of the elongated hole 1114 provided in the lateral registration adjusting plate 1151a with respect to the lateral registration adjusting pin 1157. The maximum adjustment amount is set to about 4 mm through 8 mm, which is a lateral registration adjustment amount usually required. When the lateral registration adjustment is performed, the storage frame 1110 is moved with respect to the front side plate unit 1156.

The moving member 1304 is held movably in the front-back direction FB with respect to each of the lateral registration adjusting plates 1151a and 1151b. In the moving member 1304, two elongated holes 1308 of which a longitudinal direction is in the front-back direction FB are formed. In other words, the moving member 1304 includes the elongated holes 1308 along the front-back direction FB. The respective two elongated holes 1308 of the moving member 1304 are engaged with slide holding shafts 1306 provided on the lateral registration adjusting plates 1151a and 1151b, respectively. In other words, the slide holding shaft 1306 is an example of a projected portion, engages with the elongated hole 1308, and is moved inside the elongated hole 1308 in the front-back direction FB. As a result, the moving member 1304 becomes movable in the front-back direction FB of the feeding module 100 with respect to the lateral registration adjusting plates 1151a and 1151b.

In addition, even when the lateral registration adjustment of the lateral registration adjusting plates 1151a and 1151b is performed with respect to the first sheet storage 111, positions of the moving member 1304 and the contacting portion 1303, which are held by the lateral registration adjusting plates 1151a and 1151b, with respect to the front side plate unit 1156 are not changed. Therefore, a positional relationship between the drawing-in unit 130 and the contacting portion 1303 is not changed. An area in which the moving member 1304 is movable may be set by a dimension of the elongated hole 1308 provided in the moving member 1304 with respect to the slide holding shaft 1306. In addition, a tension spring 1307 is connected to the moving member 1304, and urges the moving member 1304 in the front direction F with respect to the lateral registration adjusting plates 1151a and 1151b. In other words, the tension spring 1307 is an example of a third urging member, is interposed between the moving member 1304 and the first sheet storage 111, and urges the moving member 1304 to the first sheet storage 111 in the front direction F, which is the direction opposite to the drawing-in direction.

### Operation upon pushing in the first sheet storage to the mounting position

FIG. 10 through FIG. 14 are side views describing an operation in which the first sheet storage 111 is pushed in from the drawn-out position to the mounting position. Since the drawing-in unit 130 and the positioning roller 125 are provided on the inner surface of the right side plate 123 of the main body frame 120, the drawing-in unit 130 and the positioning roller 125 may not be seen from an outside, however, in FIG. 10 through FIG. 14, the drawing-in unit 130 and the positioning roller 125 are shown so as to be visible for description.

FIG. 10 is a side view of a state in which the first sheet storage 111 is drawn out to the drawn-out position for a user to replenish and/or exchange the sheet to the first sheet storage 111. At this time, the claw portion 1301 of the drawing-in unit 130 and the contacting portion 1303 do not contact. The moving member 1304 holding the contacting portion 1303 is urged in the front direction F of the main body frame 120 by the tension spring 1307, so that the moving member 1304 is positioned. By this positioning, when the user supplies and/or exchanges the sheet, it becomes possible to secure a space for inserting a hand, and it becomes possible to avoid contact with the moving member 1304.

FIG. 11 is a side view when the first sheet storage 111 is pushed in from the drawn-out position in the back direction B, and the claw portion 1301 contacts the contacting portion 1303. By this contact, the claw portion 1301 engages with the contacting portion 1303, and is drawn in by the drawing-in spring 1310 of the drawing-in unit 130. FIG. 12 and FIG. 13 are side views when the first sheet storage 111 is drawn in in the back direction B of the main body frame 120 in the state in which the claw portion 1301 is engaged with the contacting portion 1303.

As from the state of FIG. 11 to the state of FIG. 12, the claw portion 1301 is drawn in by the length of the elongated hole 1308 provided in the moving member 1304 which holds the contacting portion 1303. Therefore, the first sheet storage 111 does not receive a force from the drawing-in unit 130 and is not drawn in. As from the state of FIG. 12 to a state of FIG. 13, after the drawing-in unit 130 draws in the claw portion 1301 by the length of the elongated hole 1308, the drawing-in unit 130 draws in the contacting portion 1303, the moving member 1304, and the first sheet storage 111 integrally. And even when the drawing-in unit 130 completes the drawing-in, the first sheet storage 111 is positioned at the drawing-in completion position before the mounting position.

In this manner, when the first sheet storage 111 is moved from the drawn-out position toward the mounting position, the first sheet storage 111 is drawn in in the back direction B by the drawing-in unit 130 by the claw portion 1301 and the contacting portion 1303 being engaged. In other words, when the claw portion 1301 is engaged with the contacting portion 1303, the drawing-in spring 1310 moves the claw portion 1301, the contacting portion 1303, and the moving member 1304 in the back direction B.

In addition, when an upstream end portion 1308a of the elongated hole 1308 in the back direction B is in contact with the slide holding shaft 1306, the drawing-in spring 1310 causes the first sheet storage 111 to be moved to the drawing-in completion position in the back direction B. In other words, when the first sheet storage 111 reaches the drawing-in completion position, which is a predetermined position between the mounting position and the drawn-out position, the drawing-in of the first sheet storage 111 by the drawing-in unit 130 is completed. Here, when the first sheet storage 111 is positioned at the drawing-in completion position, the claw portion 1301 abuts against the abutting portion 1302 in the back direction B (see FIG. 8). In this manner, when the claw portion 1301 abuts against the abutting portion 1302, the urging force by the drawing-in spring 1310 becomes larger than the urging force by the tension spring 1307.

When the first sheet storage 111 is pushed in from the state shown in FIG. 13, the slide holding shaft 1306 is moved inside the area of the elongated hole 1308 of the moving member 1304. At this time, the first sheet storage 111 receives a reaction force of the pushing-out spring 126, but is not affected by the urging force of the drawing-in unit 130.

FIG. 14 is a side view when the first sheet storage 111 is pushed in to the mounting position. By urging the first sheet storage 111 in the back direction B of the main body frame 120 by a hand of the user, etc., the first sheet storage 111 is pushed in to the mounting position so that the latch unit 127 is in the engaged state. As a result, the first sheet storage 111 is mounted to the mounting position.

### Operation upon drawing out the first sheet storage from the mounting position

In the state shown in FIG. 14, by sending an input signal to the first sheet storage 111 and causing the solenoid 1163 (see FIG. 4) to be driven, the engagement between the latch claw 1158 and the positioning roller 125 is released. By the pushing-out spring 126 provided on the back side plate 124 of the main body frame 120, the first sheet storage 111 is urged in the front direction F of the feeding module 100, and the first sheet storage 111 and the slide holding shaft 1306 are moved in the front direction F of the feeding module 100. At this time, when the first sheet storage 111 is moved from the mounting position toward the drawing-in completion position, the claw portion 1301 and the contacting portion 1303 engaged with each other are moved relative to the first sheet storage 111 and are not moved to the main body frame 120. As a result, the first sheet storage 111 is automatically drawn out by the urging force of the pushing-out spring 126 without receiving the effects from the drawing-in spring 1310 and the damper 1309 of the drawing-in unit 130.

When the slide holding shaft 1306 is moved inside the elongated hole 1308, the slide holding shaft 1306 and the moving member 1304 contact each other, and the slide holding shaft 1306 receives a reaction force from the moving member 1304, the movement of the first sheet storage 111 stops. As a result, the first sheet storage 111 is in the state of being drawn out to the drawing-in completion position shown in FIG. 13. When the first sheet storage 111 is drawn out to the drawing-in completion position, it becomes possible for a user to grip the handle 1305, so that the user can draw out the first sheet storage 111 to the drawn-out position for the user to supply and/or exchange the sheet.

As described above, according to the present Embodiment, when the first sheet storage 111 is drawn in by the drawing-in unit 130 from the drawn-out position toward the mounting position, the drawing-in is completed at the drawing-in completion position before the mounting position. Therefore, compared to a case of being drawn in to the mounting position directly, it becomes possible to reduce impact upon mounting.

In addition, according to the present Embodiment, the moving member 1304, which is movable with respect to the main body frame 120, is used. Therefore, when a user pushes in the first sheet storage 111 from the drawing-in completion position to the mounting position, the first sheet storage 111 does not receive the effects from the drawing-in spring 1310 and the damper 1309 of the drawing-in unit 130. Therefore, compared to a case of receiving the effects from the drawing-in spring 1310 and the damper 1309, it becomes possible to improve operability.

In addition, according to the present Embodiment, when the first sheet storage 111 is positioned at the mounting position, the handle 1305 is shielded. As a result, it becomes possible to prevent an erroneous operation such that a user draws out the first sheet storage 111 during feeding of the sheet, for example. In addition, when drawing out the first sheet storage 111, by a simple operation of only releasing the latch unit 127, it becomes possible to draw out the first sheet storage 111 by the urging force of the pushing-out spring 126.

Incidentally, in the Embodiment described above, the case in which the contacting portion 1303 is provided on the first sheet storage 111 side and the drawing-in unit 130 is provided on the main body frame 120 side has been described, however, it is not limited thereto. For example, it may be configured that the contacting portion is provided on the main body frame 120 side, and the drawing-in unit is provided on the first sheet storage 111 side. In other words, it may be configured that the contacting portion is provided on either one of the main body frame 120 and the first sheet storage 111, and the drawing-in unit is provided on the other one of the main body frame 120 and the first sheet storage 111.

In addition, in the Embodiment described above, in the latch unit 127, the case in which the latch claw 1158 is provided on the first sheet storage 111 side and the positioning roller 125 is provided on the main body frame 120 side has been described, however, it is not limited thereto. For example, it may be configured that the latch claw is provided on the main body frame 120 side, and the positioning roller is provided on the first sheet storage 111 side. In other words, it may be configured that the latch claw is provided on either one of the main body frame 120 and the first sheet storage 111, and the positioning roller is provided on the other one of the main body frame 120 and the first sheet storage 111.

In addition, in the Embodiment described above, the first sheet storage 111, the second sheet storage 112, and the third sheet storage 113 are described as the sheet accommodating portion and as the moving unit, however, it is not limited thereto but may be applied to other moving units. For example, in an image forming apparatus which forms a toner image on a sheet, the Embodiment described above may be applied to a moving unit, which is capable of being drawn out from an apparatus main body, such as a toner collecting device.

In addition, in the Embodiment described above, the case in which the feeding module 100, which does not include the image forming portion, is applied as the sheet feeding device has been described, however, it is not limited thereto. For example, in an image forming apparatus including a sheet feeding portion and an image forming portion, the sheet feeding portion may be applied as the sheet feeding device.

In addition, in the Embodiment described above, the recording portion 230 including an inkjet head is applied as the image forming portion, however, it is not limited thereto. For example, an image forming portion of electrophotographic type which transfers and fixes a toner image to a sheet may be applied.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2025-078354, filed May 9, 2025, which is hereby incorporated by reference herein in its entirety.

What is claimed is:

1. A sheet feeding device comprising:
a casing;
a sheet accommodating portion movably provided between a mounting position at which the sheet accommodating portion is mounted to the casing and a drawn-out position drawn out of the casing and configured to accommodate a sheet;
an engaged portion provided on either one of the casing and the sheet accommodating portion; and
a drawing-in unit provided on the other one of the casing and the sheet accommodating portion, and provided with an engaging portion engageable with the engaged portion and a first urging member connected to the engaging portion and configured to generate an urging force to draw in the sheet accommodating portion in a drawing-in direction from the drawn-out position toward the mounting position,
wherein in a case in which the sheet accommodating portion is moved from the drawn-out position toward the mounting position, the engaging portion and the engaged portion are in engagement with each other and the movement of the sheet accommodating portion in the drawing-in direction is stated by the first urging member of the drawing-in unit, and then, when the sheet accommodating portion reaches a predetermined position between the mounting position and the drawn-out position, the movement of the sheet accommodating portion in the drawing-in direction by the first urging member of the drawing-in unit is stopped.

2. The sheet feeding device according to claim 1, wherein the engaged portion is provided on the sheet accommodating portion, and
wherein the drawing-in unit is provided on the casing.

3. The sheet feeding device according to claim 2, wherein the engaged portion is movably provided on the sheet accommodating portion in the drawing-in direction.

4. The sheet feeding device according to claim 3, wherein in a case in which the sheet accommodating portion is moved between the predetermined position and the mounting position, the engaging portion and the engaged portion engaged with each other are moved relative to the sheet accommodating portion and are not moved to the casing.

5. The sheet feeding device according to claim 3, further comprising a second urging member provided on the casing and configured to urge the sheet accommodating portion in a direction opposite to the drawing-in direction from the mounting position, and
a holding unit displaceable between a holding state of holding the sheet accommodating portion at the mounting position and a releasing state of releasing the holding,
wherein in a case in which the sheet accommodating portion is positioned in the mounting position and the holding unit is in the releasing state, the second urging member urges the sheet accommodating portion toward the predetermined position and moves the sheet accommodating portion from the mounting position.

6. The sheet feeding device according to claim 5, wherein the sheet accommodating portion includes a gripping portion which is gripped by a user when the sheet accommodating portion is drawn out,
wherein the casing includes a shielding portion for shielding the griping portion when the sheet accommodating portion is in the mounting position,
wherein the gripping portion is exposed when the sheet accommodating portion is in the predetermined position.

7. The sheet feeding device according to claim 5, wherein when the sheet accommodating portion is moved from the mounting position toward the predetermined position, the engaging portion and the engaged portion engaged with each other are moved relative to the sheet accommodating portion and are not moved to the casing.

8. The sheet feeding device according to claim 3, further comprising a moving member movably provided to the sheet accommodating portion in the drawing-in direction,
wherein the engaged portion is provided on the moving member.

9. The sheet feeding device according to claim 8, wherein the moving member includes an elongated hole along the drawing-in direction,
wherein the sheet accommodating portion is engaged with the elongated hole and includes a projected portion moving inside the elongated hole in the drawing-in direction.

10. The sheet feeding device according to claim 9, wherein in a case in which the sheet accommodating portion is moved from the drawn-out position toward the drawing-in direction,
when the engaging portion is engaged with the engaged portion, the first urging member causes the engaging portion and the engaged portion and the moving member to be moved in the drawing-in direction, and
when an upstream end portion of the elongated hole in the drawing-in direction is in contact with the projected portion, the first urging member causes the sheet accommodating portion to be moved to the predetermined position in the drawing-in direction.

11. The sheet feeding device according to claim 8, further comprising a third urging member interposed between the moving member and the sheet accommodating member and configured to urge the moving member to the sheet accommodating portion in a direction opposite to the drawing-in direction.

12. The sheet feeding device according to claim 11, wherein the drawing-in unit includes an abutting portion against which the engaging portion abuts when the sheet accommodating portion is positioned at the predetermined position,
wherein when the engaging portion abuts against the abutting portion, the urging force due to the first urging member is larger than an urging force due to the third urging member.

13. The sheet feeding device according to claim 1, wherein the drawing-in unit further includes a damping member configured to damp movement of the sheet accommodating portion to the drawing-in direction,
wherein when the sheet accommodating portion reaches the predetermined position between the mounting position and the drawn-out position, the movement of the sheet accommodating portion by the first urging member and the damping member of the drawing-in unit is stopped.

14. An image forming apparatus comprising:
the sheet feeding device according to claim 1; and
an image forming portion configured to form an image on a recording material accommodated in and fed by the sheet feeding device from the sheet accommodating portion.
